(19) United States
(12) Patent Application Publication
(10) Pub. No.: US 2012/0066884 A1
(43) Pub. Date: Mar. 22, 2012

(54) ASSEMBLY FACILITATION APPARATUS AND METHOD

(76) Inventor: Bernd P. Daeschner, Fairview, PA (US)

(21) Appl. No.: 12/886,666

(22) Filed: Sep. 21, 2010

(51) Int. Cl. B25B 27/02; B23P 11/02; B25B 11/00

(52) U.S. Cl. 29/447; 29/281.1; 29/281.3; 29/721; 29/800; 29/428

(57) ABSTRACT

An assembly apparatus including a bearing support mechanism configured to hold a bearing for assembly into a housing and a housing register mechanism operatively connected to the bearing support mechanism. The housing register mechanism receives and aligns a housing with a bearing on the bearing support mechanism when the housing is placed over the housing register mechanism.

### FIELD OF THE INVENTION

Embodiments of the invention relate generally to an assembly facilitation apparatus and method and, in particular, to an apparatus for seating a bearing in a bearing housing.

### BACKGROUND OF THE INVENTION

Wind turbine systems are conventionally known. Such systems generally include a rotor head to which wind turbine blades are attached, a main shaft coupled to the rotor head so as to integrally rotate with the rotor head, a gear box coupled to the main shaft that rotates by means of wind power received by the wind turbine blades, and an electrical generator driven by an output shaft from the gear box. The gearbox and generator are typically housed in a nacelle mounted atop a tower.

In use, the wind turbine blades transform wind energy into a rotational torque or force that drives the electrical generator. The gearbox is used to step up the inherently slow rotation, high torque of the turbine rotor to a much higher rotation and lower torque for input into the electrical generator. In this manner, the gearbox provides a high speed, low torque output to the generator suitable for the production of electricity.

Conventional gear boxes for use with wind turbines can weigh several tons and typically contain numerous stages and gears to achieve an overall gear ratio from 40:1 to over 100:1, depending on the size of the turbine. As will be appreciated, assembling such large and heavy components found in wind turbine gear boxes presents several problems. In particular, seating bearings, such as carrier bearings or downwind race bearings, within their respective high weight housings has proven difficult. Accordingly, there is a need for an apparatus that facilitates the assembly of specific components of a gearbox, and optimizes the time required to install bearings, to an extent presently unknown.

### BRIEF DESCRIPTION OF THE INVENTION

According to one embodiment of the invention, an assembly apparatus includes a bearing support mechanism and a housing register mechanism. The bearing support mechanism is configured to hold a bearing for assembly into a housing. The housing register mechanism is operatively connected to the bearing support structure for receiving and aligning the housing with respect to the bearing on the bearing support structure when the housing is placed over the housing register mechanism.

According to another embodiment, an assembly apparatus includes a bearing support mechanism, a housing register mechanism, and a press mechanism. The bearing support mechanism receives a carrier bearing for assembly into a bearing housing. The housing register mechanism is connected to the bearing support mechanism by an adjustable shaft. The press mechanism is operable to seat the carrier bearing in the bearing housing. The housing register mechanism receives and aligns the bearing housing with the carrier bearing when the bearing housing is lowered over the housing register mechanism.

Another embodiment relates to a method for assembling a gearbox. The method includes placing a bearing on a bearing support mechanism, lowering a bearing housing over the bearing and bearing support mechanism and onto a housing register mechanism to align the bearing within the bearing housing, and seating the bearing within the bearing housing.

### BRIEF DESCRIPTION OF THE DRAWINGS

The present invention will be better understood from reading the following description of non-limiting embodiments, with reference to the attached drawings, wherein below:

FIG. 1 is an isometric view of a base portion of an assembly apparatus in accordance with an embodiment of the inventive apparatus for aligning and seating a bearing within a bearing housing.

FIG. 2 is side elevational view of the base portion of the assembly apparatus of FIG. 1.

FIG. 3 is an isometric view of a base portion of an assembly apparatus having a housing register system in accordance with the present invention.

FIG. 4 is a side elevational view of the base portion of the assembly apparatus of FIG. 3

FIG. 5 is an isometric view of a bearing support portion of the assembly apparatus in accordance with an embodiment of the inventive apparatus for aligning and seating a bearing within a bearing housing.

FIG. 6 is a side elevational view of the bearing support portion of the assembly apparatus of FIG. 5

FIG. 7 is a top plan view of the assembly apparatus in accordance with an embodiment of the inventive apparatus for aligning and seating a bearing within a bearing housing.

### DETAILED DESCRIPTION OF THE INVENTION

Reference will be made below in detail to exemplary embodiments of the invention, examples of which are illustrated in the accompanying drawings. Wherever possible, the same reference numerals used throughout the drawings refer to the same or like parts.

As described in detail below, an embodiment of the present invention provides an apparatus for seating a bearing within a housing that facilitates the assembly of a gearbox for use in wind turbine systems and optimizes the time required to install gearbox bearings. The bearings may be carrier bearings or downwind race bearings, although many other types of bearings known in the art may also be used in connection with the present invention for assembly into a housing. Embodiments of the inventive apparatus include beneficial alignment features, as well as supporting structures and seating mechanisms.

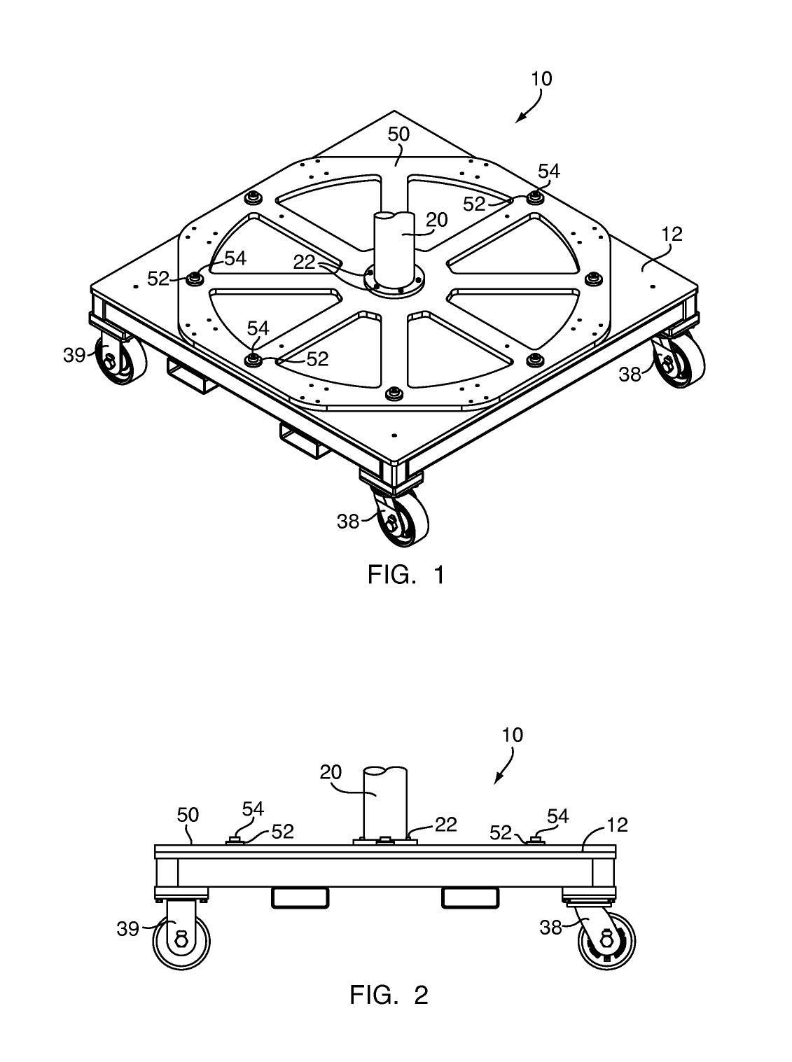

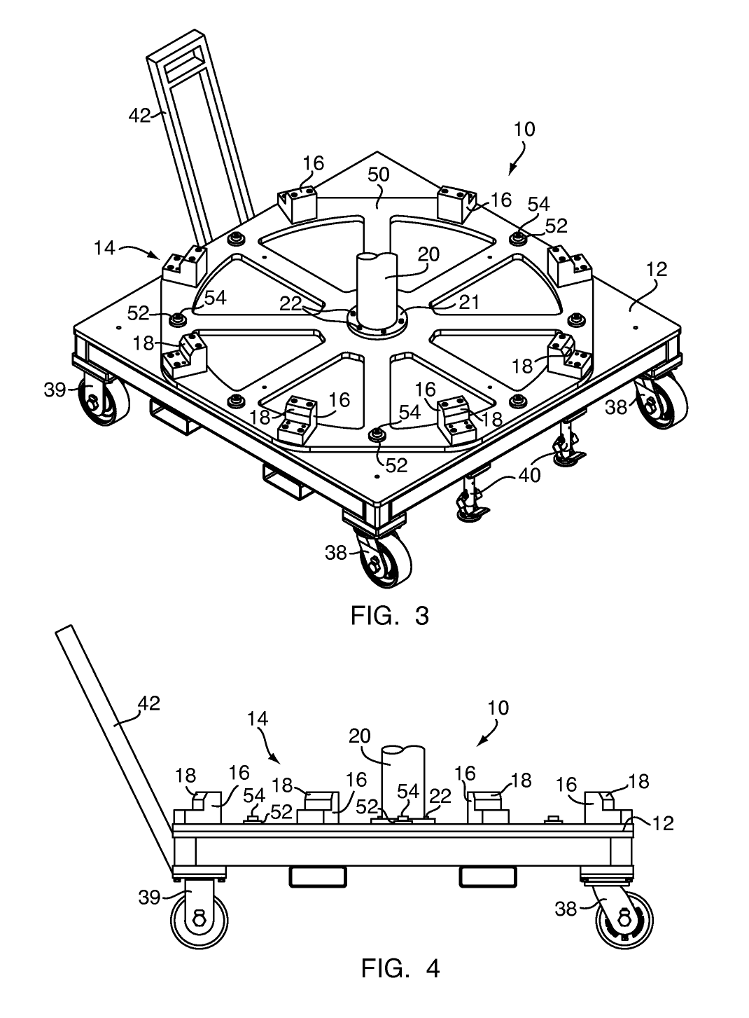

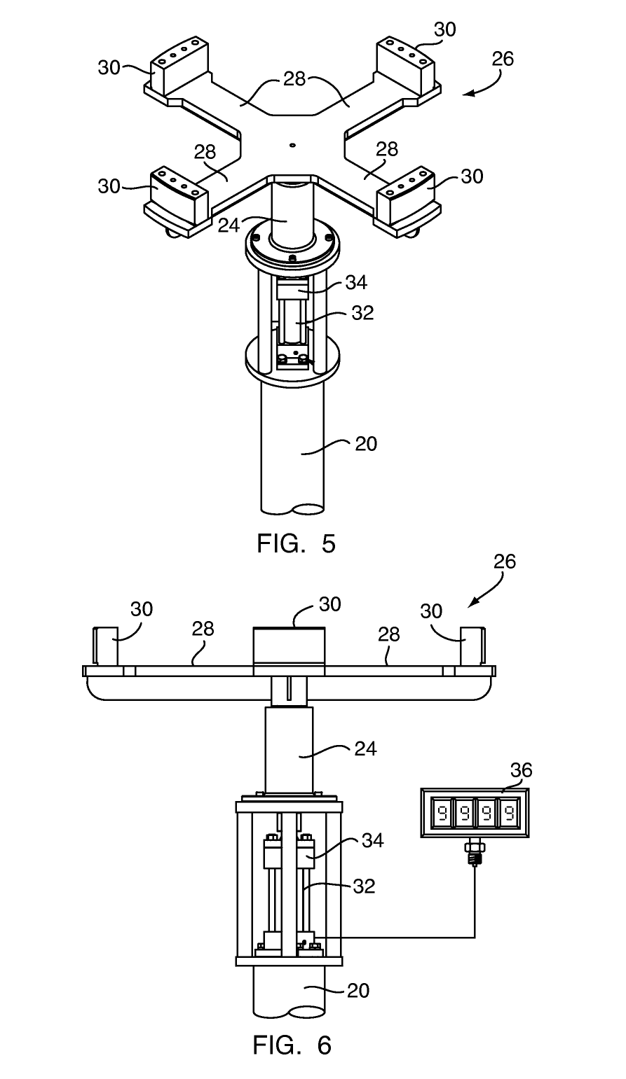

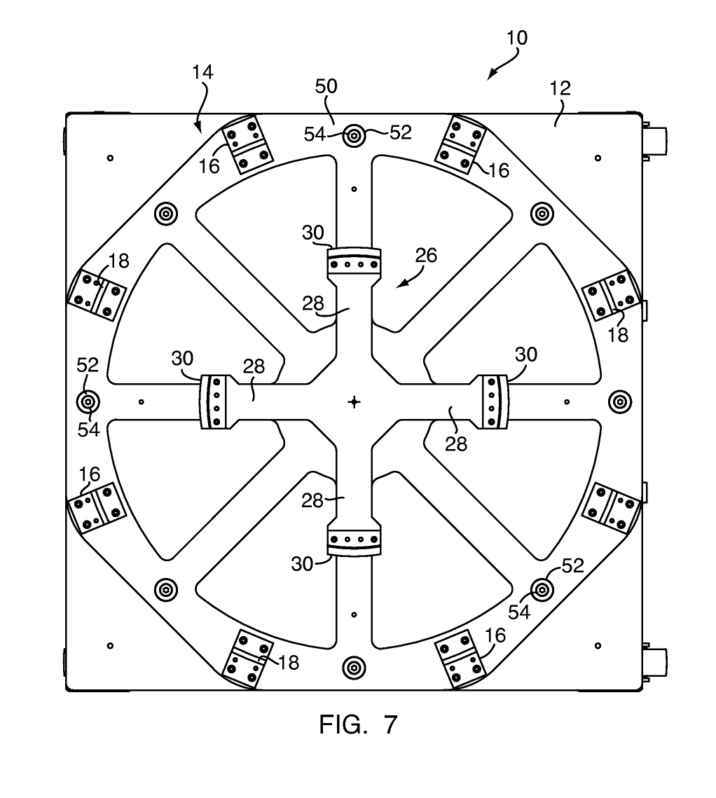

Referring generally to FIGS. 1-7, an embodiment of the assembly apparatus 10 of the present invention generally takes the form of a cart and includes a base 12 (e.g., cart base). The cart base 12 may have a housing register system 14 disposed on a generally planar surface thereof. The cart base 12 is generally square or rectangular, although other configurations are also possible. The housing register system 14 includes a plurality of housing alignment seats 16 fixedly attached to the cart base 12 and arranged in a substantially circular configuration (or other peripheral configuration, corresponding to the bearing housing) for receiving and aligning a high weight casting or housing (not shown) with a bearing (not shown), as discussed in detail below. The alignment seats 16 have a beveled surface 18 for facilitating the registering of the casting/housing on the cart base 12 and with the bearing. “Casting” and “housing” are used synonymously herein to refer to a structure (part of a gear box or other mechanical device to be assembled using the assembly apparatus) that receives a bearing. In addition, as used herein and as used in the claims, the terms “housing register system” and “housing register mechanism” are synonymous.

A center post 20 having a lower flange 21 is rigidly affixed to the cart base 12 by a first plurality of socket head cap screws 22 (or other fasteners) and extends upwards from the center of the circle formed by the housing alignment seats 16. An adjustable shaft or guide post 24 having a bearing support structure 26 is slidably nested within an upper portion of the center post 20 and is operable to seat the bearing in the housing, as discussed in detail below. The bearing support structure 26 generally includes a frame having a plurality of support arms 28 (or, more generally, the bearing support mechanism includes at least one support arm) extending radially from the center of the guide post 24, each support arm having a alignment guide, e.g. bearing seat 30, on the respective distal end thereof for supporting and aligning the bearing to be seated in the housing. As used herein and as used in the claims, the terms “bearing support structure” and “bearing support mechanism” are synonymous.

A press mechanism, e.g., hydraulic cylinder 32, having a push pad 34 is mounted within the center post 20 below the guide post 24. The press mechanism/hydraulic cylinder 32 is operable to extend (or retract) the guide post 24 from the center post 20 and to urge the bearing into a seated position in the housing. The hydraulic cylinder 32 may optionally include, or be coupled to, a pressure gauge 36 for sensing a pressure exerted by the cylinder 32. The pressure gauge 36 may also include a feedback loop so that the when the pressure gauge 36 reaches or detects a certain threshold pressure, extension of the hydraulic cylinder 32 is stopped. In addition, the pressure gauge 36 can be used to detect if the bearing is fully seated in the housing after assembly through pressure pre-measurement.

In addition to the above, the cart base 12 may be fitted with a plurality of wheels 38, 39 (e.g., casters) for supporting the assembly apparatus 10 and for facilitating movement thereof. The wheels may be attached to an underside of the cart base 12 by hex bolts and lock washers, although other attachment means known in the art may also be used.

In one embodiment, the apparatus 10 has two swivel casters 38 and two rigid casters 39, although other configurations such as four swivel casters are possible. The swivel casters 38 and rigid casters 39, or other cart legs, may be height adjustable. In addition, the underside of the cart base 12 may be fitted with a braking mechanism such as one or more foot brakes 40 to enable a user to lock the cart base in place such that it will not roll or move from its set location. As with the swivel casters 38, 39, the foot brakes 40 may be fixedly attached to the underside of the cart base 12 by hex bolts and lock washers, although other attachment means known in the art may also be used. The foot brakes 40 may be coupled to the swivel casters 38, 39 to prevent the wheels thereof from turning, thereby locking the apparatus 10 in place.

In an alternative embodiment, the assembly apparatus includes a heating element, such as an induction coil, operatively attached to the center post of the apparatus 10 for heating the bearing, to expand the same, when the bearing is mounted on the assembly apparatus. Similarly, an embodiment could further include a cooling apparatus depending on the manufacturing parameters. Such a cooling apparatus could include a closed loop recirculator or a gas expanding nozzle proximate to the bearing.

The assembly apparatus 10 also has an attachment mechanism, such as a tongue hitch 42, for allowing the apparatus to be attached to motive power or to another assembly apparatus or cart. The total weight of the assembly apparatus, including all components hereinbefore described, may be on the order of 2,500 pounds.

During assembly, a carrier bearing or downwind race bearing or other bearing is placed on the bearing support structure 26, and is aligned and held in place by support arms 28 and center post 20. The bearing may be taken directly from a cooling chamber and placed directly on the bearing support structure 26. A sensor may detect a position of the bearing to assess whether the bearing is aligned and seated on the support structure 26. The housing is then lowered over the apparatus 10 and the bearing and is aligned and seated on housing alignment seats 16. The bevels 18 on the alignment seats aid to register the housing on the cart base 12 and in alignment with the bearing.

The hydraulic press or cylinder 32 located in the center post 20 is then actuated to press upwards, thereby extending the guide post 24 and bearing support structure 26 upwards to seat and properly align the bearing within the housing. Another sensor may be used to assess whether the bearing is properly aligned and seated within the housing. A top carrier bearing, or upwind race bearing, may then be set in place from the top and the entire assembly transported to final assembly.

The assembly apparatus may also include a float mechanism or system operatively attached to the cart base 12. The float system generally includes an annular or semi-annular float plate 50 mounted to the cart base by a plurality of float washers 52 and shoulder bolts 54. In this embodiment, the float plate 50 is mounted directly to the cart base 12, and the housing alignment seats 16 are fixedly attached to the top of the float plate 50. The float plate 50 has a plurality of spokes extending from a periphery thereof to the center for operative attachment to the center post 20.

The float system allows for play between the housing and the housing alignment seats 16 to prevent damage to the housing or the alignment seats 16 due to misalignment. In particular, the holes through which the shoulder bolts 54 are provided are oversized to allow for translational movement of the float plate 50 relative to the cart base 12 such that if the housing is not precisely aligned with the alignment seats 16, the float plate and alignment seats 16 may automatically shift into a proper alignment position, due to urging by the housing, prior to the housing being completely lowered and seated on the cart base 12.

In use, an embodiment of the inventive apparatus may include a bearing support mechanism configured to hold a bearing for assembly into a housing, a housing register mechanism operatively connected to the bearing support mechanism and configured to receive and align the housing with respect to a bearing on the bearing support mechanism when the housing is placed over the housing register mechanism, and a press mechanism for seating the bearing within the housing. The housing register mechanism may include housing alignment seats having a beveled edge. In certain circumstances, this embodiment may omit the above-referenced press mechanism without departing from the spirit and scope of invention.

In other embodiments the apparatus may include, in addition to the above, a plurality of wheels supporting the apparatus and a braking mechanism coupled to at least one of the plurality of wheels.

In yet other embodiments, the housing register mechanism may be connected to the bearing support mechanism by a height-adjustable shaft and the press mechanism may be a hydraulic cylinder. In this embodiment, the press mechanism may optionally include a pressure gauge.

In an embodiment, the apparatus may include an attachment mechanism allowing the apparatus to be attached to motive power or another apparatus, and/or may also include a sensor to assess whether the bearing is aligned and seated within the housing.

An embodiment of the present invention contemplates a method of assembling a gearbox. The method includes the steps of placing a bearing on a bearing support mechanism, lowering a bearing housing over the bearing and bearing support mechanism and onto a housing register mechanism to align the bearing within the housing, and seating the bearing within the bearing housing.

Another embodiment relates to an assembly apparatus for assembling a gear box or part of a gear box. The assembly apparatus comprises a base, a bearing support mechanism, a press mechanism, and a housing register mechanism. Each of a plurality of wheels is attached to an underside of the base, for facilitating movement of the assembly apparatus along a floor or other support surface. The housing register mechanism is attached to a top side of the base. The bearing support mechanism is also attached to the top side of the base, and comprises (i) an adjustable-length shaft that extends upwards from the top side of the base, (ii) at least one support arm attached to a distal end of the shaft (opposite the base), and (iii) at least one alignment guide/bearing seat attached to the at least one support arm for supporting and aligning a bearing. The housing register receives and aligns a bearing housing with respect to the bearing on the bearing support mechanism when the housing is placed over the housing register mechanism. The press mechanism is operably connected to the shaft, for selectively extending and retracting the shaft in order to seat the bearing in the bearing housing. The housing register may comprise a plurality of housing alignment seats, attached to the top side of the base and arranged in a peripheral configuration around the shaft for receiving and aligning the bearing housing.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the parameters of the invention, they are by no means limiting and are exemplary embodiments. Many other embodiments will be apparent to those of skill in the art upon reviewing the above description. The scope of the invention should, therefore, be determined with reference to the appended claims, along with the full scope of equivalents to which such claims are entitled.

In the appended claims, the terms “including” and “in which” are used as the plain-English equivalents of the respective terms “comprising” and “wherein.” Moreover, in the following claims, the terms “first,” “second,” “third,” “upper,” “lower,” “bottom,” “top,” “up,” “down,” etc. are used merely as labels, and are not intended to impose numerical or positional requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose several embodiments of the invention, including the best mode, and also to enable any person skilled in the art to practice the embodiments of invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

Since certain changes may be made in the above-described apparatus without departing from the spirit and scope of the invention herein involved, it is intended that all of the subject matter of the above description or shown in the accompanying drawings shall be interpreted merely as examples illustrating the inventive concept herein and shall not be construed as limiting the invention.

What is claimed is:

1. An assembly apparatus, the apparatus comprising:
a bearing support mechanism configured to hold a bearing for assembly into a housing;
a housing register mechanism operatively connected to the bearing support mechanism; and
wherein the housing register mechanism receives and aligns the housing with respect to the bearing on the bearing support mechanism when the housing is placed over the housing register mechanism.

2. The assembly apparatus of claim 1, further comprising a press mechanism, operatively connected to the bearing support mechanism and/or the housing register mechanism, for seating the bearing in the housing.

3. The assembly apparatus of claim 2, further comprising a base supporting the bearing support mechanism and the housing register mechanism, and a plurality of wheels supporting the base.

4. The assembly apparatus of claim 3, further comprising a braking mechanism coupled to at least one of the plurality of wheels.

5. The assembly apparatus of claim 2, wherein the housing register mechanism is operatively connected to the bearing support mechanism by a shaft having an adjustable length.

6. The assembly apparatus of claim 5, wherein the press mechanism comprises a hydraulic cylinder in the shaft to urge the bearing into a seated position in the housing.

7. The assembly apparatus of claim 6, wherein the press mechanism further comprises a pressure gauge for sensing a pressure exerted by the hydraulic cylinder.

8. The assembly apparatus of claim 1, further comprising a heating mechanism to heat the bearing while the bearing is on the apparatus.

9. The assembly apparatus of claim 1, further comprising an attachment mechanism allowing the apparatus to be attached to motive power or another apparatus.

10. An assembly apparatus, the apparatus comprising:
a bearing support mechanism that receives a carrier bearing for assembly into a bearing housing;
a housing register mechanism connected to the bearing support mechanism by an adjustable shaft, the housing register mechanism receives and aligns the bearing housing with respect to the carrier bearing when the bearing housing is lowered over the housing register mechanism; and
a press mechanism for seating the carrier bearing in the bearing housing.

11. The assembly apparatus of claim 10, wherein the bearing support mechanism comprises:
a frame, and
a plurality of alignment guides on the frame, the alignment guides being arranged about the adjustable shaft,
wherein the alignment guides receive and align the carrier bearing with respect to the bearing housing when the housing is lowered over the bearing support mechanism.

12. The assembly apparatus of claim 10, wherein the housing register mechanism includes a plurality of housing alignment seats having a beveled edge portion to facilitate alignment of the bearing housing with respect to the carrier bearing.

13. The apparatus of claim 12, further comprising a base supporting the bearing support mechanism and the housing register mechanism, and a float mechanism operatively connected to the housing register mechanism, the float mechanism configured to move relative to base to facilitate alignment of the bearing housing on the housing register mechanism.

14. The assembly apparatus of claim 10, wherein the press mechanism comprises a hydraulic cylinder operably connected to the shaft to urge the carrier bearing into a seated position in the bearing housing.

15. The apparatus of claim 10, further comprising a heating mechanism to heat the carrier bearing while the bearing is on the apparatus.

16. A method of assembling a gearbox, the method comprising the steps of:
placing a bearing on a bearing support mechanism;
lowering a bearing housing over the bearing and bearing support mechanism and onto a housing register mechanism to align the bearing within the bearing housing; and
seating the bearing within the bearing housing.

17. The method of claim 16, further comprising the step of:
heating the bearing on the bearing support mechanism.
